(19) United States
(12) Patent Application Publication
(10) Pub. No.: US 2009/0073364 A1
(43) Pub. Date: Mar. 19, 2009

(54) Lateral electric-field type Liquid Crystal Display device and method of fabricating the same

(75) Inventor: Fumihiko Matsuno, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki (JP)

(21) Appl. No.: 12/216,627

(22) Filed: Jul. 8, 2008

(30) Foreign Application Priority Data
Jul. 9, 2007 (JP) 2007-179351

(51) Int. Cl. G02F 1/1333

(52) U.S. Cl. 349/138; 349/187

(57) ABSTRACT

A liquid crystal display device improves the adhesion property between the organic transparent insulating film and the transparent electrodes formed thereon and the transmittance of the insulating film in the non-electrode regions, thereby increasing the display brightness while preventing the defective patterning of the electrodes. An organic transparent insulating film is formed on or over a transparent substrate. The organic transparent insulating film includes a reformed layer in its surface. Transparent electrodes are formed on the organic transparent insulating film to be in contact with the reformed layer. In electrode regions where the transparent electrodes are present, the reformed layer has a first thickness. In non-electrode regions where the transparent electrodes are not present, the reformed layer is not present, or a remainder of the reformed layer is present in such a way as to have a thickness less than the first thickness.

### BACKGROUND OF THE INVENTION

1. Field of the Invention

The present invention relates to a Liquid Crystal Display (LCD) device and a method of fabricating the same. More particularly, the invention relates to a lateral electric-field type LCD device whose transparent electrodes are formed on an organic transparent insulating film while a patterned reformed layer of the organic transparent insulating film intervenes between the electrodes and the inner part of the insulating film, and a method of fabricating the LCD device.

2. Description of the Related Art

The LCD device displays images by applying electric field to the liquid crystal layer sandwiched by two opposing transparent substrates to thereby rotate the liquid crystal molecules in the liquid crystal layer. The LCD device has two typical types; one of which is the vertical electric-field type where it is operated in, for example, the TN (Twisted Nematic) mode. With this type, electric field perpendicular to the liquid crystal layer (i.e., vertical electric field) is generated using the electrodes formed on one of the two opposing transparent substrates and the electrodes formed on the other, thereby rotating the liquid crystal molecules toward the direction perpendicular to the said substrates.

The other type is the lateral electric-field type where the device is operated in, for example, the IPS (In-Plane Switching) or FPS (Fringe Field Switching) mode. With this type, electric field parallel to the liquid crystal layer (i.e., lateral electric field) is generated using the electrodes formed on one of the two opposing transparent substrates, thereby rotating the liquid crystal molecules toward the direction parallel to the said substrates.

An example of the active-matrix addressing LCD device of the lateral electric-field type is disclosed in the Japanese Non-Examined Patent Publication No. 2002-323706 (Patent Document 1). (See Abstract and FIG. 2 of the Patent Document 1.) The schematic structure of this prior-art LCD device is shown in FIG. 1.

As shown in FIG. 1, the prior-art LCD device comprises a transparent active element substrate 111, a transparent opposite substrate 112, and a liquid crystal layer 113 held in such a way as to be sandwiched between the substrates 111 and 112. The active element substrate 111 comprises a second transparent interlayer Insulating film 114 on its inside. Transparent common electrodes 115 and transparent pixel electrodes 116 are formed on the second interlayer insulating film 114. Each of the common electrodes 115 and the pixel electrodes 116 is comb-shaped. Each of the common electrodes 115 and a corresponding one of the pixel electrodes 116 are mated with each other in each of the pixel regions. Therefore, in FIG. 1, the comb-tooth-shaped parts of the common electrode 115 and those of the corresponding pixel electrode 116 are aligned alternately. The second interlayer insulating film 114 is made of a photosensitive acrylic resin. The common electrodes 115 and the pixel electrodes 116 are made of ITO (Indium Tin Oxide), which is a transparent conductive material.

The common electrodes 115 and the pixel electrodes 116 are covered with an alignment film 117 that is formed on the second interlayer insulating film 114. The inner surface of the opposite substrate 112 is covered with an alignment film 118. The inner surfaces of the alignment films 117 and 118 have been subjected to a predetermined aligning treatment processes, respectively. The liquid crystal molecules in the liquid crystal layer 113 are in contact with the aligning-treated inner surfaces of the alignment films 117 and 118 and therefore, these molecules are initially aligned to a predetermined direction in planes parallel to the substrates 111 and 112.

When a predetermined voltage is applied across the common electrodes 115 and the corresponding pixel electrodes 116, electric field parallel to the substrates 111 and 112 (i.e., lateral electric field) is generated. The liquid crystal molecules in the liquid crystal layer 113 are rotated from their initial alignment direction by the lateral electric field in the planes parallel to the substrates 111 and 112 and as a result, images are displayed. In this way, the orientation of the liquid crystal molecules is always kept in the planes parallel to the substrates 111 and 112, and the liquid crystal molecules are never rotated toward the directions perpendicular to the substrates 111 and 112. For this reason, the lateral electric-field type LCD device has an advantage that brightness change and color change dependent on the viewing angle can be reduced.

It is known that in the case where an ITO film is formed on a transparent insulating film made of an organic material such as acrylic or polyimide resin (i.e., an organic insulating film) and then, the ITO film is patterned by photolithography and wet etching to form transparent electrodes such as pixel electrodes thereon, the defective patterning is likely to occur. For example, the line-widths of the patterned ITO film (i.e., the transparent electrodes) are likely to be smaller than the desired ones, and/or the patterned ITO film itself is easily peeled off from the organic insulating film. The cause of this defective patterning is that the adhesion strength between the ITO film and the organic insulating film is poor and as a result, the etchant used in the wet etching is prone to enter the interface between the ITO film and the organic insulating film.

Measures to solve such the problem as above are disclosed in the Japanese Non-Examined Patent Publication No. 4-257826 (Patent Document 2) and the Japanese Patent No. 3612529 (which corresponds to the Japanese Non-Examined Patent Publication No. 2003-207774) (Patent Document 3).

The method of fabricating an active-matrix substrate disclosed in the Patent Document 2 is as follows. The surface of an organic transparent insulating film made of an organic material such as acrylic or polyimide resin is treated in an atmosphere containing plasma of an inert gas such as argon (Ar). Thereafter, a transparent conductive film such as an ITO film is formed on the organic transparent insulating film and patterned by photolithography and wet etching, thereby forming transparent electrodes such as pixel electrodes. (See FIG. 1 and claim 1 of the Patent Document 2.)

In this way, with the fabrication method disclosed in the Patent Document 2, the surface of the organic transparent insulating film is reformed by the plasma treatment using an inert gas to improve the adhesion property between the said organic transparent insulating film and the transparent electrodes formed thereon, thereby preventing the defective patterning of the transparent electrodes.

The method of fabricating a semi-transmissive type LCD device disclosed in the Patent Document 3 is as follows. The surface of an organic insulating film is plasma-treated using helium (He) to form a reformed layer in the surface of the said insulating film. The surface of the reformed layer thus formed is washed and then, a transparent conductive film such as an ITO film is formed on the reformed layer. Subsequently, the transparent conductive film thus formed is patterned to form transparent electrodes with desired shapes. (See claim 1 and FIGS. 3 to 11 of the Patent Document 3.)

With the fabrication method disclosed in the Patent Document 3 also, similar to the method of the Patent Document 2, the adhesion property between the organic insulating film and the transparent conductive film is improved by the formation of the reformed layer in the surface of the organic insulating film, thereby preventing the defective patterning of the transparent electrodes.

With the above-described prior-art methods of forming transparent electrodes on an organic transparent Insulating film disclosed in the Patent Documents 2 and 3, an organic transparent insulating film is surface-treated in an atmosphere containing plasma of an inert gas and thereafter, a transparent conductive film is formed thereon. Thereafter, the transparent conductive film thus formed is patterned to form transparent electrodes such as pixel electrodes, thereby improving the adhesion property between the organic transparent insulating film and the transparent conductive film. These two prior-art methods may be applied to the vertical electric-field type LCD device operating in the TN mode.

However, if one of the above prior-art methods of improving the adhesion property by the reformed layer is applied to the lateral electric-field type LCD device operating in the IPS mode, the following problems will occur.

Specifically, if the surface of an organic transparent insulating film is treated by the method disclosed in the Patent Document 2 or 3, a reformed layer with a high refractive index is formed in the surface of the said organic transparent insulating film due to the decomposition and recombination of the molecules. Therefore, the reflection of the light at the surface of the reformed layer of the organic transparent insulating film is increased. As a result, the overall transmittance of the said organic insulating film is reduced.

With the LCD device operating in the TN mode, the patterned transparent conductive film (i.e., the transparent electrodes) is left on the reformed layer in the areas through which the light is to be transmitted. This is because the difference between the refractive indices of the transparent conductive film and the reformed layer is small, and the reflection at the boundary between the said conductive film and the said reformed layer is suppressed. Therefore, the transmittance deterioration of the said insulating film due to the reformed layer can be suppressed. Accordingly, the reflection problem will not be caused by the reformed layer.

Unlike this, with the LCD device operating in the IPS mode (see FIG. 1) where either the common electrodes 115 or the pixel electrodes 116 or both of them are formed by the transparent conductive film on the organic transparent insulating film, the light needs to transmit through not only the areas where the common and pixel electrodes 115 and 116 are placed on the second interlayer insulating film 114 (i.e., the organic transparent insulating film) but also the areas where the common and pixel electrodes 115 and 116 are not placed thereon. Therefore, if the prior-art method disclosed in the Patent Document 2 or 3 is applied to the step of forming the common electrodes 115 and/or the pixel electrodes 116, the reflection problem will occur due to the reformed layer. Specifically, the transmittance deteriorates in the areas where the common and pixel electrodes 115 and 116 do not exist on the second interlayer insulating film 114 (i.e., the organic transparent insulating film) and as a result, a problem of lowering the display brightness will arise.

This problem will occur in the LCD device operating in the FFS mode also.

### SUMMARY OF THE INVENTION

The present invention was created to eliminate the above-described problem in the lateral electric-field type LCD device.

An object of the present invention is to provide a LCD device that improves the adhesion property between an organic transparent insulating film and transparent electrodes formed thereon and the transmittance of the organic transparent insulating film in the areas where the electrodes do not exist (i.e., the non-electrode regions), thereby increasing the display brightness while preventing the defective patterning of the electrodes, and a method of fabricating the device.

The above object together with others not specifically mentioned will become clear to those skilled in the art from the following description.

According to the first aspect of the present invention, a LCD device is provided, which comprises:

a transparent substrate;

an organic transparent insulating film formed on or over the substrate, the organic transparent insulating film including a reformed layer in its surface; and

transparent electrodes formed on the organic transparent insulating film to be in contact with the reformed layer;

wherein in electrode regions where the transparent electrodes are present, the reformed layer has a first thickness; and

in non-electrode regions where the transparent electrodes are not present, the reformed layer is not present, or a remainder of the reformed layer is present in such a way as to have a thickness less than the first thickness.

With the LCD device according to the first aspect of the present invention, in the electrode regions where the transparent electrodes are present, the transparent electrodes are formed on the organic transparent insulating film to be in contact with the reformed layer, where the reformed layer has the first thickness. Moreover, in the non-electrode regions where the transparent electrodes are not present, the reformed layer is not present such that the inner part of the organic transparent insulating film is exposed (where the thickness of the reformed layer is zero), or the reformed layer is present in such a way as to have the thickness less than the first thickness. Therefore, the optical transmittance deterioration or lowering due to the formation of the reformed layer in the non-electrode regions is relaxed, and the obtainable transmittance will be equal or close to the original transmittance of the organic transparent insulating film. Accordingly, compared with the case where the reformed layer is not partially or entirely removed in the non-electrode regions, the display brightness of the said LCD device is improved.

In addition, since the transparent electrodes are in contact with the reformed layer in the electrode regions, the improved adhesion property between the transparent electrodes and the organic transparent insulating film due to the formation of the reformed layer is kept unchanged. Thus, the defective pattering of the transparent electrodes does not occur.

As a result, the display brightness can be increased while the defective patterning of the transparent electrodes is prevented.

In a preferred embodiment of the device according to the first aspect of the invention, in the non-electrode regions, a predetermined level difference is generated between a surface of an inner part of the organic transparent insulating film or the remainder of the reformed layer, and surfaces of the transparent electrodes; and

the level difference is set at a value in a range where the disclination of liquid crystal molecules does not occur.

In this embodiment, even if depressions and projections (i.e., unevenness) that reflect the level difference are generated in an alignment film that covers the transparent electrodes, the disclination of the liquid crystal molecules can be prevented.

In another preferred embodiment of the device according to the first aspect of the invention, the level difference is set at a value in a range from 100 nm to 20 nm. If the value of the level difference exceeds 100 nm, the alignment of the liquid crystal molecules is distorted due to the level difference and as a result, the disclination of the liquid crystal molecules is likely to occur. On the other hand, to make the transparent electrodes function as desired, the transparent electrodes needs to be 10 nm or more in thickness. To realize desired optical transmittance improvement of the organic transparent insulating film, the removal thickness or depth of the reformed layer needs to be 10 nm or more in thickness. Therefore, it is preferred that the level difference is 20 nm or more.

In still another preferred embodiment of the device according to the first aspect of the invention, the reformed layer is not present such that an inner part of the organic transparent insulating film is exposed in the non-electrode regions.

In this embodiment, since the reformed layer is not present (i.e., the thickness of the reformed layer is zero) in the non-electrode regions, the transmittance deterioration is eliminated, and the transmittance of the organic transparent insulating film is equal to the original transmittance thereof. Accordingly, there is an additional advantage that the display brightness of the said LCD device can be raised to a level equivalent to the level obtainable in the case where the reformed layer is not formed.

In a further preferred embodiment of the device according to the first aspect of the invention, the remainder of the reformed layer whose thickness is less than the first thickness is present, and an inner part of the organic transparent insulating film is not exposed from the remainder in the non-electrode regions.

In this embodiment, it is unnecessary that the whole thickness of the reformed layer is removed in the non-electrode regions. Therefore, this embodiment is suitable for the case where the level difference formed by removing the whole thickness of the reformed layer is excessively large, and some problem (e.g., disclination) will occur.

In a still further preferred embodiment of the device according to the first aspect of the invention, the transparent electrodes are pixel electrodes and/or common electrodes. In this case, the advantages of the invention are conspicuous.

In a still further preferred embodiment of the device according to the first aspect of the invention, the device is operated in one of the IPS mode and the FPS mode.

In a still further preferred embodiment of the device according to the first aspect of the invention, the organic transparent insulating film is made of one of acrylic resin and polyimide resin.

In a still further preferred embodiment of the device according to the first aspect of the invention, the reformed layer is formed by surface treatment of the organic transparent insulating film in an atmosphere containing plasma of an inert gas.

According to the second aspect of the present invention, a method of fabricating a LCD device is provided. This method comprises the steps of:
forming an organic transparent insulating film on or over a transparent substrate;
reforming a surface of the organic transparent insulating film, thereby forming a reformed layer in the surface of the organic transparent insulating film, wherein the reformed layer has a first thickness;
forming a transparent conductive film on the reformed layer;
selectively removing the transparent conductive film, thereby forming transparent electrodes, wherein the transparent electrodes are in contact with the reformed layer, and the reformed layer is exposed in non-electrode regions where the transparent electrodes are not present; and
selectively removing the exposed reformed layer in the non-electrode regions along a thickness direction of the organic transparent insulating film, thereby removing the reformed layer or reducing a thickness of the reformed layer;
wherein in the non-electrode regions, the reformed layer is not present, or a remainder of the reformed layer is present in such a way as to have a thickness less than the first thickness.

With the method of fabricating a LCD device according to the second aspect of the present invention, the transparent conductive film is selectively removed to form the transparent electrodes, wherein the transparent electrodes are in contact with the reformed layer, and the reformed layer is exposed in the non-electrode regions. Thereafter, the exposed reformed layer in the non-electrode regions is selectively removed along the thickness direction of the organic transparent insulating film, thereby reducing the thickness of the reformed layer. In the non-electrode regions, the reformed layer is not present, or the remainder of the reformed layer is present in such a way as to have the thickness less than the first thickness (i.e., the thickness in the electrode regions). Therefore, the optical transmittance deterioration or lowering due to the formation of the reformed layer in the non-electrode regions is relaxed, and the obtainable transmittance will be equal or close to the original transmittance of the organic transparent insulating film. Accordingly, compared with the case where the reformed layer is not partially or entirely removed in the non-electrode regions, the display brightness of the said LCD device is improved.

In addition, since the transparent electrodes are in contact with the reformed layer in the electrode regions, the improved adhesion property between the transparent electrodes and the organic transparent insulating film due to the formation of the reformed layer is kept unchanged. Thus, the defective pattering of the transparent electrodes does not occur.

As a result, the display brightness can be increased while the defective patterning of the transparent electrodes is prevented.

In a preferred embodiment of the method according to the second aspect of the invention, in the step of selectively removing the exposed reformed layer to reduce the thickness thereof, a predetermined level difference is generated between a surface of an inner part of the organic transparent insulating film or the remainder of the reformed layer, and surfaces of the transparent electrodes in the non-electrode regions; and

the level difference is set at a value in a range where disclination of liquid crystal molecules does not occur.

In this embodiment, even if depressions and projections (i.e., unevenness) that reflect the level difference are generated in an alignment film that covers the transparent electrodes, the disclination of the liquid crystal molecules can be prevented.

In another preferred embodiment of the method according to the second aspect of the invention, the level difference is set at a value in a range from 100 nm to 20 nm. The reason of the upper and lower limits of this range is the same as explained for the LCD device according to the first aspect of the invention.

In still another preferred embodiment of the method according to the second aspect of the invention, in the step of selectively removing the exposed reformed layer to reduce the thickness thereof, a removal thickness or depth of the reformed layer is greater than the first thickness;

wherein the reformed layer is not present such that an inner part of the organic transparent insulating film is exposed in the non-electrode regions.

In this embodiment, since the reformed layer is not present (i.e., the thickness of the reformed layer is zero) in the non-electrode regions, the transmittance deterioration by the reformed layer does not occur, and the transmittance of the organic transparent insulating film is equal to the original transmittance thereof. Accordingly, there is an additional advantage that the display brightness of the said LCD device can be raised to a level equivalent to the level obtainable in the case where the reformed layer is not formed.

In a further preferred embodiment of the method according to the second aspect of the invention, in the step of selectively removing the exposed reformed layer to reduce the thickness thereof, a removal thickness or depth of the reformed layer is less than the first thickness;

wherein the remainder of the reformed layer whose thickness is less than the first thickness is present, and an inner part of the organic transparent insulating film is not exposed from the remainder in the non-electrode regions.

In this embodiment, it is unnecessary that the whole thickness of the reformed layer is removed in the non-electrode regions. Therefore, this embodiment is suitable for the case where the level difference formed by removing the whole thickness of the reformed layer is excessively large, and some problem (e.g., disclination) will occur.

In a still further preferred embodiment of the method according to the second aspect of the invention, the step of selectively removing the exposed reformed layer to reduce the thickness thereof is carried out by dry etching using one selected from the group consisting of (a) oxygen gas (O₂), (b) a gaseous mixture of sulfur hexafluoride (SF₆) and helium (He), (c) a gaseous mixture of carbon tetrafluoride (CF₄) and oxygen (O₂). (d) a gaseous mixture of trifluoromethane (CHF₃) and oxygen (O₂), and (d) a gaseous mixture of carbon tetrafluoride (CF₄), trifluoromethane (CHF₃), and oxygen (O₂), as an etching gas. In this embodiment, the reformed layer can be etched away efficiently while the effects to be applied to other parts are reduced as small as possible.

In a still further preferred embodiment of the method according to the second aspect of the invention, the organic transparent insulating film is formed by one of acrylic resin and polyimide resin.

In a still further preferred embodiment of the method according to the second aspect of the invention, in the step of selectively removing the exposed reformed layer to reduce the thickness thereof, the transparent electrodes are used as a mask.

In this embodiment, another mask is unnecessary for the said step and thus, the fabrication processes are simplified.

In a still further preferred embodiment of the method according to the second aspect of the invention, in the step of selectively removing the exposed reformed layer to reduce the thickness thereof, a same mask as that used in the step of selectively removing the transparent conductive film to form transparent electrodes is used.

In this embodiment, another mask is unnecessary for the said step and thus, the fabrication processes are simplified. In addition, because the transparent electrodes are still covered with the mask in the step of selectively removing the exposed reformed layer, the bad effects applied to the transparent electrodes by the etchant used in this step can be decreased.

In a still further preferred embodiment of the method according to the second aspect of the invention, in the step of reforming the surface of the organic transparent insulating film, the reformed layer is formed by surface treatment of the organic transparent insulating film in an atmosphere containing plasma of an inert gas.

In this embodiment, it is preferred that at least one selected from the group consisting of helium (He), argon (Ar), and nitrogen (N₂) is used as the inert gas. In this case, the reformed layer having a desired property is easily produced.

### BRIEF DESCRIPTION OF THE DRAWINGS

In order that the present invention may be readily carried into effect, it will now be described with reference to the accompanying drawings.

FIG. 1 is a cross-sectional view showing the schematic structure of a prior-art LCD device.

FIG. 2 is a partial plan view of a TFT array substrate used in a LCD device operating in the IPS mode according to a first embodiment of the present invention.

FIG. 3 is a partial cross-sectional view of the TFT array substrate along the line III-III in FIG. 2.

FIG. 4 is a partial cross-sectional view of the TFT array substrate along the line IV-IV in FIG. 2.

FIG. 5 is a partial cross-sectional view of the LCD device along the line III-III in FIG. 2.

FIGS. 6A, 6D and 6C are partial cross-sectional views showing the process steps of a method of fabricating the LCD device according to the first embodiment of the invention, respectively, where FIG. 6A shows the cross-sectional structure of the TFT section taken along the line IV-IV in FIG. 2, FIG. 6B shows the cross-sectional structure of the pixel section taken along the line III-III in FIG. 2, and FIG. 6C shows the cross-sectional structure of the contact hole section for the common electrode taken along the line XIIC-XIIC in FIG. 2.

FIGS. 7A, 75 and 7C are partial cross-sectional views showing the process steps of the method of fabricating the LCD device according to the first embodiment of the invention, which are subsequent to the step of FIGS. 6A, 6B, and 6C, respectively, where FIG. 7A shows the cross-sectional structure of the TFT section taken along the line IV-IV in FIG. 2, FIG. 7B shows the cross-sectional structure of the pixel section taken along the line III-III in FIG. 2, and FIG. 7C shows the cross-sectional structure of the contact hole section for the common electrode taken along the line XIIC-XIIC in FIG. 2.

FIGS. 8A, 8B and 8C are partial cross-sectional views showing the process steps of the method of fabricating the LCD device according to the first embodiment of the invention, which are subsequent to the step of FIGS. 7A, 7B, and 7C, respectively, where FIG. 8A shows the cross-sectional structure of the TFT section taken along the line IV-IV in FIG. 2, FIG. 8B shows the cross-sectional structure of the pixel section taken along the line III-III in FIG. 2, and FIG. 8C shows the cross-sectional structure of the contact hole section for the common electrode taken along the line XIIC-XIIC in FIG. 2.

FIGS. 9A, 9B and 9C are partial cross-sectional views showing the process steps of the method of fabricating the LCD device according to the first embodiment of the invention, which are subsequent to the step of FIGS. 8A, 8B, and 8C, respectively, where FIG. 9A shows the cross-sectional structure of the TFT section taken along the line IV-IV in FIG. 2, FIG. 9B shows the cross-sectional structure of the pixel section taken along the line III-III in FIG. 2, and FIG. 9C shows the cross-sectional structure of the contact hole section for the common electrode taken along the line XIIC-XIIC in FIG. 2.

FIGS. 10A, 10B and 10C are partial cross-sectional views showing the process step of the method of fabricating the LCD device according to the first embodiment of the invention, which are subsequent to the steps of FIGS. 9A, 9B, and 9C, respectively, where FIG. 10A shows the cross-sectional structure of the TFT section taken along the line IV-IV in FIG. 2. FIG. 10B shows the cross-sectional structure of the pixel section taken along the line III-III in FIG. 2, and FIG. 10C shows the cross-sectional structure of the contact hole section for the common electrode taken along the line XIIC-XIIC in FIG. 2.

FIGS. 11A, 11B and 11C are partial cross-sectional views showing the process steps of the method of fabricating the LCD device according to the first embodiment of the invention, which are subsequent to the step of FIGS. 10A, 10B, and 10c, respectively, where FIG. 11A shows the cross-sectional structure of the TFT section taken along the line IV-IV in FIG. 2, FIG. 11B shows the cross-sectional structure of the pixel section taken along the line III-III in FIG. 2, and FIG. 11C shows the cross-sectional structure of the contact hole section for the common electrode taken along the line XIIC-XIIC in FIG. 2.

FIGS. 12A, 12B and 12C are partial cross-sectional views showing the process steps of the method of fabricating the LCD device according to the first embodiment of the invention, which are subsequent to the step of FIGS. 11A, 11B, and 11C, respectively, where FIG. 12A shows the cross-sectional structure of the TFT section taken along the line IV-IV in FIG. 2, FIG. 12B shows the cross-sectional structure of the pixel section taken along the line III-III in FIG. 2, and FIG. 12C shows the cross-sectional structure of the contact hole section for the common electrode taken along the line XIIC-XIIC in FIG. 2.

FIGS. 13A, 13B and 13C are partial cross-sectional views showing the process steps of a method of fabricating a LCD device according to a second embodiment of the invention, respectively, where FIG. 13A shows the cross-sectional structure of the TFT section taken along the line IV-IV in FIG. 2. FIG. 13B shows the cross-sectional structure of the pixel section taken along the line III-III in FIG. 2, and FIG. 13C shows the cross-sectional structure of the contact hole section for the common electrode taken along the line XIIC-XIIC in FIG. 2.

FIGS. 14A, 14B and 14C are partial cross-sectional views showing the process steps of the method of fabricating the LCD device according to the second embodiment of the invention, which are subsequent to the step of FIGS. 13A, 13B, and 13C, respectively, where FIG. 14A shows the cross-sectional structure of the TFT section taken along the line IV-IV in FIG. 2, FIG. 14B shows the cross-sectional structure of the pixel section taken along the line III-III in FIG. 2, and FIG. 14C shows the cross-sectional structure of the contact hole section for the common electrode taken along the line XIIC-XIIC in FIG. 2.

FIG. 15 is a partial cross-sectional view of a TFT array substrate used in a LCD device operating in the FFS mode according to a third embodiment of the present invention.

FIG. 16 is a partial plan view of the TFT array substrate used in the LCD device operating in the FFS mode according to the third embodiment of the invention.

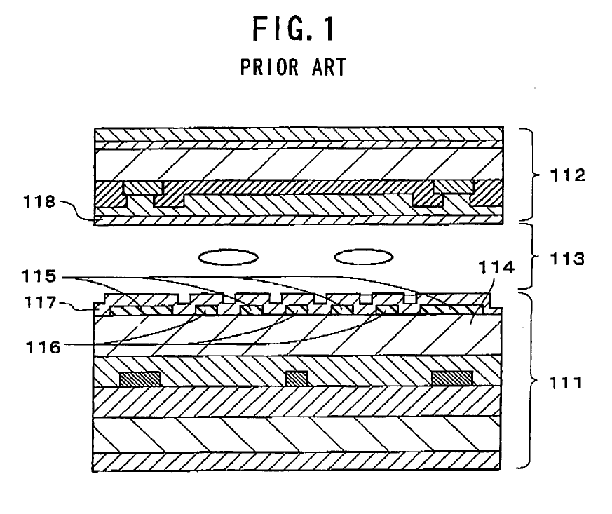

### DETAILED DESCRIPTION OF THE PREFERRED EMBODIMENTS

Preferred embodiments of the present invention will be described in detail below while referring to the drawings attached.

### Device Structure of First Embodiment

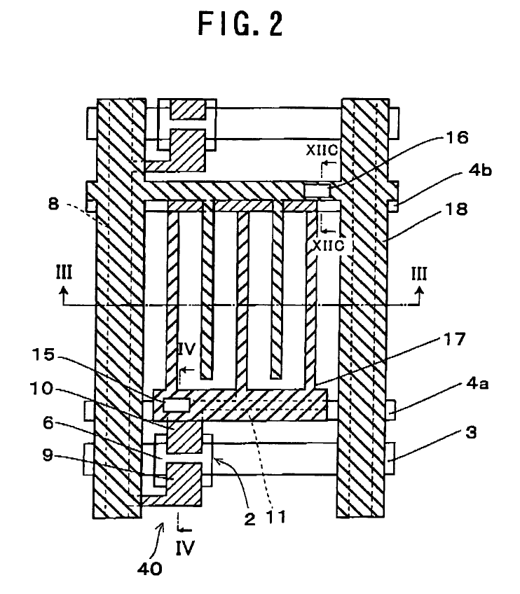

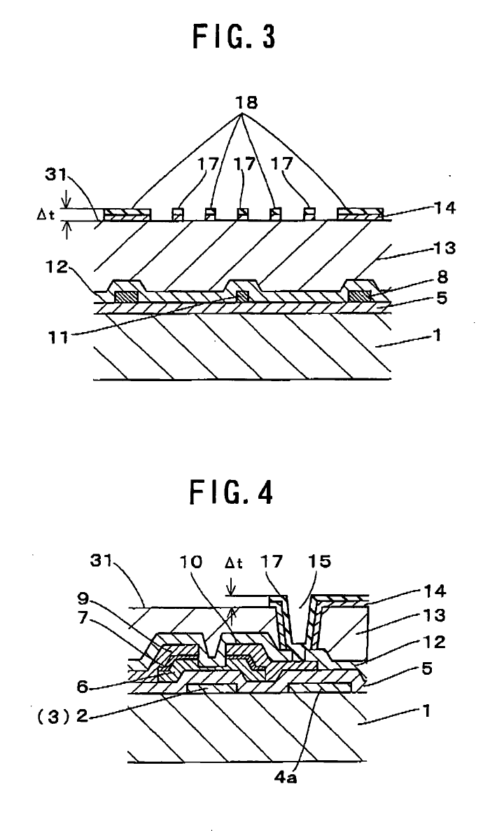

A TFT (Thin-Film Transistor) array substrate used in a lateral electric-field type LCD device according to a first embodiment of the present invention is shown in FIG. 2. This LCD device is designed to operate In the IPS mode. In addition, the partial cross-sectional structures of this device along the lines III-III and IV-IV in FIG. 2 are shown in FIGS. 3 and 4, respectively. These figures show the structure of one of the pixel regions arranged in a matrix array.

As shown in FIG. 2, the TFT array substrate comprises gate lines 3 extending laterally (i.e., from side to side) and data lines 8 extending vertically (i.e., up and down). The gate lines 3 and the data lines 8 are electrically insulated from each other by a gate insulating film 5. The gate lines 3 are arranged vertically at predetermined intervals. The data lines 8 are arranged laterally at predetermined intervals. The gate lines 3 and the data lines 8 are intersected at right angles to define the approximately rectangular pixel regions.

A pixel electrode 17 as a transparent electrode is formed in each of the pixel regions. The pixel electrode 17 is comb-tooth shaped. A common electrode 18 as another transparent electrode is commonly used for all the pixel regions. The common electrode 18 comprises comb-tooth-shaped parts located in the respective pixel regions and stripe-shaped parts that interconnect the said comb-tooth-shaped parts. The comb-tooth-shaped part of the common electrode 18 existing in each pixel region is arranged in such a way as to mate with the corresponding comb-tooth-shaped pixel electrode 17 existing in the said pixel region. The stripe-shaped parts of the common electrode 18, which are overlapped with the corresponding data lines 8, extend vertically along the data lines 8 in FIG. 2.

In each of the pixel regions, a TFT 40 is provided near a corresponding one of the intersections of the gate and data lines 3 and 8. A gate electrode 2 of the TFT 40 is formed in such a way as to be united with a corresponding one of the gate lines 3 and therefore, the gate electrode 2 and the corresponding gate line 3 are electrically interconnected. A source electrode 9 of the TFT 40 is formed in such a way as to be united with a corresponding one of the data lines 8 and therefore, the source electrode 9 and the corresponding data line 8 are electrically interconnected. A drain electrode 10 of the TFT 40 is electrically connected to a corresponding one of the pixel electrodes 17 by way of a corresponding contact hole 15.

Two common electrode lines 4a and 4b are formed parallel to each of the gate lines 3. The common electrode line 4b is electrically connected to the common electrode 18 by way of a corresponding contact hole 16. The comb-tooth-shaped pixel electrode 17 and the comb-tooth-shaped part of the common electrode 18 mating therewith in the pixel region extend vertically parallel to the data lines 8. The strip-shaped parts of the common electrodes 18 are located over the corresponding data lines 8 to cover the same completely. An auxiliary pixel electrode 11, which has a H-like plan shape, is placed in the pixel region to overlap with the common electrode lines 4a and 4b.

FIG. 3 snows the cross-sectional structure of the said TFT array substrate, which is taken along the line III-III in FIG. 2. The gate insulating film 5 is formed on the surface of a transparent plate 1 made of glass or the like. The data lines 8 and the auxiliary pixel electrodes 11, which are formed on the gate insulating film 5, are covered with a passivation film 12 formed on the gate insulating film 5. A thick organic transparent insulating film 13, which is made of an organic transparent insulative material such as acrylic resin and polyimide resin, is formed on the passivation film 12.

The pixel electrodes 17 and the common electrode 18, which have been formed by patterning a transparent conductive film such as an ITO film, are formed on a patterned reformed layer 14 of the transparent organic insulating film 13. The patterned reformed layer 14 is selectively formed in the surface of the insulating film 13. The pixel electrodes 17 and the common electrode 18 are not formed directly on the exposed surface 31 of the inner part (which has not been reformed) of the organic insulating film 13. The patterned reformed layer 14 intervenes between the pixel and common electrodes 17 and 18, and the surface 31 of the inner part (i.e., the non-reformed part) of the insulating film 13. Therefore, the pixel electrodes 17 and the common electrode 18 are in contact with the reformed layer 14.

As explained later, the reformed layer 14 is a part of the transparent organic insulating film 13 that has been formed by the plasma treatment of the surface of the said film 13. It may be said that the reformed layer 14 is a part of the insulating film 13 whose transmittance of light has been lowered. This low transmittance of the reformed layer 14 is caused by the increase of the refractive index or reflectivity of light at the boundary surface of the said layer 14, i.e., at the original surface of the insulating film 13. Since the reformed layer 14 has the same pattern as those of the pixel and common electrodes 17 and 18, the reformed layer 14 is not present in the areas where the pixel and common electrodes 17 and 18 do not exist.

In this way, in the areas where the pixel and common electrodes 17 and 18 do not exist (i.e., the non-electrode regions), the original surface of the organic insulating film 13 is selectively removed to have a depth greater than the thickness of the reformed layer 14 and therefore, the reformed layer 14 whose transmittance is lower than that of the inner part of the insulating film 13 is not present. The inner part of the insulating film 13, which has not been reformed and which is adjacent to the reformed layer 14, is exposed in the non-electrode regions. The exposed surface of the inner part of the insulating film 13 is denoted by “31”.

As a result, in the non-electrode regions, the exposed surface 31 of the inner part of the insulating film 13 is lower in height than the original surface of the insulating film 13 (i.e. the surface of the reformed layer 14) located under the pixel and common electrodes 17 and 18, forming depressions whose depth is equal to the removal thickness of the insulating film 13. In other words, a level difference Δt (“Delta t”) is generated between the exposed surface 31 of the inner part (i.e., the non-reformed part) of the insulating film 13 in the non-electrode regions, and the surfaces of the pixel and common electrodes 17 and 18 in the electrode regions. It is preferred that the value or amount of the level difference Δt is set at 100 nm or less, the reason of which is as follows:

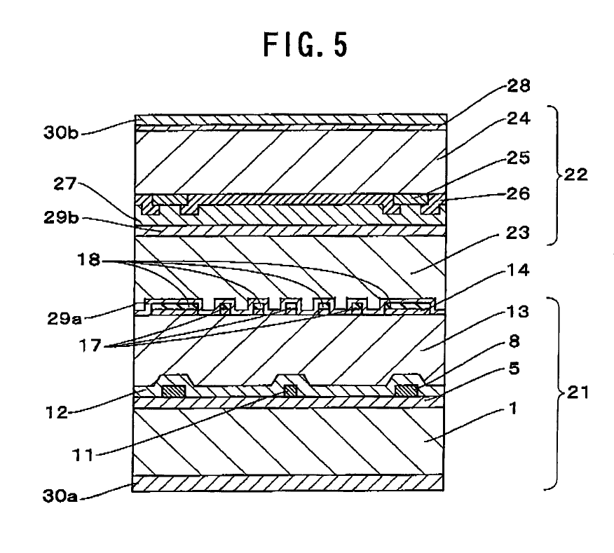

As explained later, the pixel and common electrodes 17 and 18 and the exposed surface 31 of the inner part of the insulating film 13 among these electrodes 17 and 18 are covered with an alignment film 29a (see FIG. 5). Therefore, depressions and projections (i.e., unevenness) that reflect the underlying level difference Δt are generated in the surface of the alignment film 29a. Since the liquid crystal molecules in a liquid crystal layer 23 are in contact with the surface of the alignment film 29a, the depressions and projections of the surface of the alignment film 29a will affect the aligning operation of the liquid crystal molecules. When the level difference Δt has a sufficiently small value, the effect by the level difference Δt to the aligning operation of the liquid crystal molecules may be ignored. However, when the value of the level difference Δt exceeds 100 nm, the said effect is unable to be ignored and as a result, the disclination of the liquid crystal molecules is likely to occur. Accordingly, it is preferred that the value of the level difference Δt is set at 100 nm or less.

On the other hand, it is preferred that the lower limit of the level difference Δt is set at 20 nm. This is because the following reason.

To make a patterned transparent conductive film (e.g., an ITO film) function as transparent electrodes (e.g., the pixel and common electrodes 17 and 18), the patterned transparent conductive film needs to have a thickness of at least 10 nm. Moreover, if the removal thickness of the reformed layer 14 is set at 10 nm or more, the transmittance improvement of the organic insulating film 13 can be realized as desired. Accordingly, it is preferred that the lower limit of the level difference Δt is set at 20 nm.

As seen from above explanation, the level difference Δt is preferably set at a value in the range from 100 nm to 20 nm according to the necessity.

According to the inventor's research, if the thickness of the alignment film 29a is large, concretely speaking, if the said thickness is greater than 100 nm, the level difference Δt is relaxed. As a result, depressions and projections whose level difference is smaller than the level difference Δt will appear in the surface of the alignment film 29a. On the other hand, if the thickness of the alignment film 29a is small, concretely speaking, if the said thickness is equal to 100 nm or less (which is not less than 20 nm), the level difference Δt is reflected to the surface of the alignment film 29a as-is. As a result, depressions and projections whose level difference is equal to the level difference Δt will appear in the surface of the alignment film 29a.

In the areas where the pixel and common electrodes 17 and 18 do not exist (i.e., the non-electrode regions), the reformed layer 14, which has been initially formed in the whole surface of the organic insulating film 13, is removed completely. Therefore, the transmittance of the insulating film 13 is equal to the original transmittance thereof in the said areas. This means that the effect of the transmittance lowering of the insulating film 13 induced by the formation of the reformed layer 14 is eliminated in the non-electrode regions.

FIG. 4 shows the cross-sectional structure of the TFT 40 taken along the line IV-IV in FIG. 2. As seen from FIG. 4, the gate electrode 2 and the common gate line 4a are formed on the surface of the transparent plate 1 and are covered with the gate insulating film 5. A semiconductor island 6 and a heavily doped semiconductor island 7 are stacked in this order on the gate insulating film 5 in such a way as to overlap with the corresponding gate electrode 2. A source electrode 9 and a drain electrode 10 are formed in such a way as to overlap with the heavily doped semiconductor island 7. The gate electrodes 2, the source electrodes 9, and the drain electrodes 10 of the TFTs 40 are covered with the passivation film 12. The organic insulating film 13 containing the patterned reformed layer 14 is formed on the passivation film 12.

A contact hole 15 for the corresponding pixel electrode 17 is formed to penetrate through the passivation film 12 and the organic insulating film 13, reaching the corresponding drain electrode 10. The pixel electrodes 17 are formed on the patterned reformed layer 14 of the insulating film 13; in other words, the pixel electrodes 17 are formed over the inner part of the insulating film 13 while the remaining reformed layer 14 intervenes between the pixel electrodes 17 and the surface 31 of the said inner part. The reformed layer 14 is present on the entire inner walls of the contact holes 15. The pixel electrode 17 is electrically connected to the corresponding drain electrode 10 by way of the corresponding contact hole 15.

FIG. 5 shows the cross-sectional structure of the lateral electric-field type LCD device according to the first embodiment taken along the line III-III in FIG. 2. As seen from FIG. 5, this LCD device is configured by combining the TFT array substrate 21 having the above-described structure with an opposite substrate 22.

On the inner surface of the TFT array substrate 21. i.e., the surface of the organic insulating film 13, the alignment film 29a is formed to cover the pixel and common electrodes 17 and 18. The inner surface of the alignment film 29a has been subjected to a rubbing treatment to a predetermined direction. A polarizer plate 30a is attached to the outer surface of the TFT array substrate 21.

The opposite substrate 22 comprises a transparent plate 24 made of glass or the like, a black matrix 25 with a predetermined pattern formed on the surface of the plate 24, color layers 26 with predetermined patterns formed on the surface of the plate 24, and an overcoat film 27 formed to cover the black matrix 25 and the color layers 26. A transparent conductive film 28 for preventing electrification is formed on the reverse of the plate 24.

An alignment film 29b is formed on the inner surface of the opposite substrate 22, i.e., the surface of the overcoat film 27. The inner surface of the alignment film 29b has been subjected to a rubbing treatment to a predetermined direction. A polarizer plate 30b is attached to the outer surface of the opposite substrate 22.

The TFT array substrate 21 and the opposite substrate 22 are combined together in such a way that the alignment films 29a and 29b are opposed to each other at an approximately constant interval. The liquid crystal layer 23 is provided between the substrates 21 and 22. A backlight unit (not shown) is placed on the rear side of the TFT array substrate 21.

With the LCD device according to the first embodiment, signal voltages are applied across the pixel electrodes 17 and the common electrode 18 to generate lateral electric field in the liquid crystal layer 23. The alignment state of the liquid crystal molecules existing in the liquid crystal layer 23 is changed utilizing the lateral electric field thus generated, thereby controlling the transmitted light from the backlight unit at each pixel to display desired images.

### Fabrication Method of First Embodiment

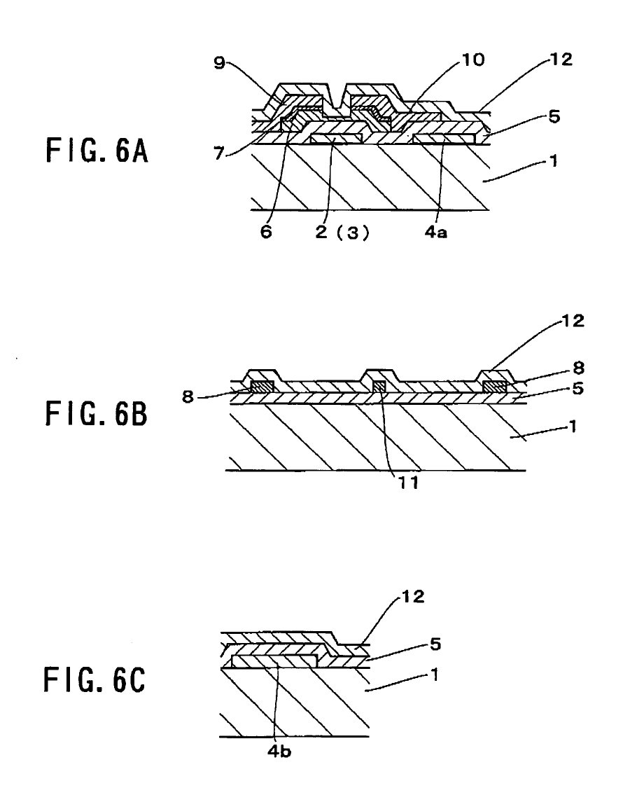

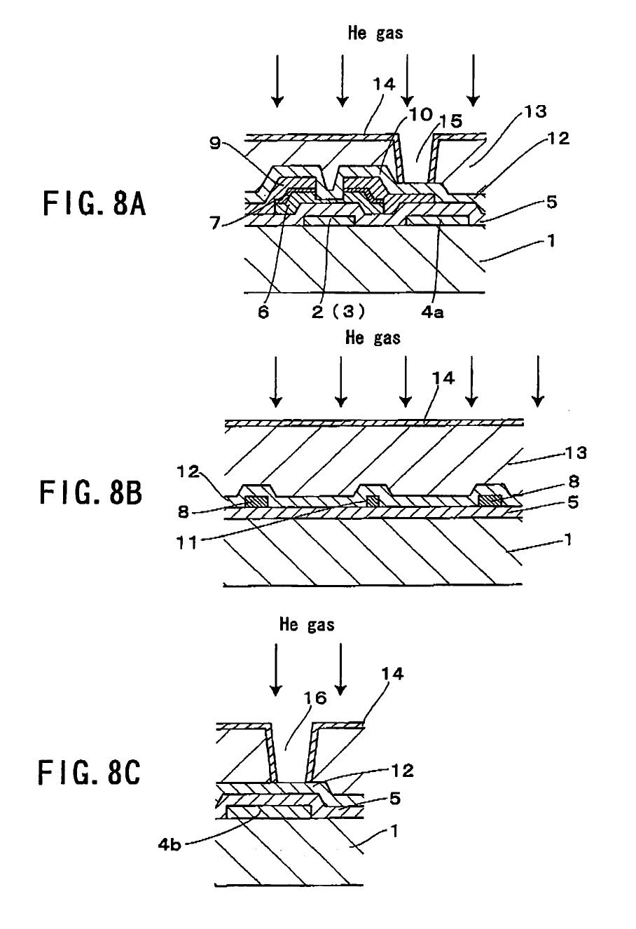

Next, a method of fabricating the LCD device according to the first embodiment having the structure shown in FIGS. 2 to 5 will be explained below with reference to FIGS. 6A to 6C to FIGS. 12A to 12C.

First, a conductive or insulative film is formed on the transparent plate 1 for the TFT array substrate 21 by sputtering or CVD (Chemical vapor Deposition) and then, the conductive or insulative film thus formed is patterned by photolithography and wet or dry etching. These process steps are repeated appropriately to form the structure of FIGS. 6A to 6C.

Concretely speaking, as a first conductive film, a single-layer film made of aluminum (Al), molybdenum (Mo), or chromium (Cr) or alloy containing one of these metals as its main constituent, or a multilayer film of at least on of these metals and/or at least one of these alloys is formed on the transparent plate 1 by sputtering or CVD. Then, the first conductive film thus formed is patterned by photolithography and wet or dry etching, thereby forming the gate electrodes 2, the gate lines 3, and the common electrode lines 4a and 4b on the surface of the transparent plate 1. Thereafter, as the gate insulating film 5, for example, a silicon nitride (SiNₓ) film, or a two-layer film of a SiN, layer and a silicon oxide (SiOₓ) layer is formed to cover the patterned first conductive film (i.e., the gate electrodes 2, the gate lines 3, and the common electrode lines 4a and 4b).

Next, to form the semiconductor islands 6 and the heavily doped semiconductor islands 7, an amorphous silicon (a-Si) or polycrystalline silicon (p-Si) film is formed on the gate insulating film 5 and then, a heavily doped a-Si or p-Si film is formed on the a-Si or p-Si film thus formed. As the heavily doped a-Si or p-Si film used here, for example, an a-Si or p-Si film heavily doped with phosphorus (P) may be used. The a-Si or p-Si film and the heavily doped a-Si or p-Si film thus formed are patterned to be islands, thereby forming the semiconductor islands 6 and the heavily doped semiconductor islands 7 located thereon.

Next, a second conductive film is formed on the gate insulating film 5 and patterned to have a predetermined shape, thereby forming the data lines 8, the source electrodes 9, the drain electrodes 10, and the auxiliary pixel electrodes 11 on the gate insulating film 5. As the second conductive film, a metal or alloy film similar to those used for the above-described first conductive film may be used. The middle parts of the heavily doped semiconductor islands 7 and the upper middle parts of the semiconductor islands 6, which are located between the source and drain electrodes 9 and 10, are selectively removed by etching, thereby forming the channel regions. In this way, the TFTs 40 are completed. Following this, as the passivation film 12, for example, a SiNₓ film is formed to cover the TFTs 40, the data lines 8, and the auxiliary pixel electrodes 11. As a result, the structures shown in FIGS. 6A to 6C are formed.

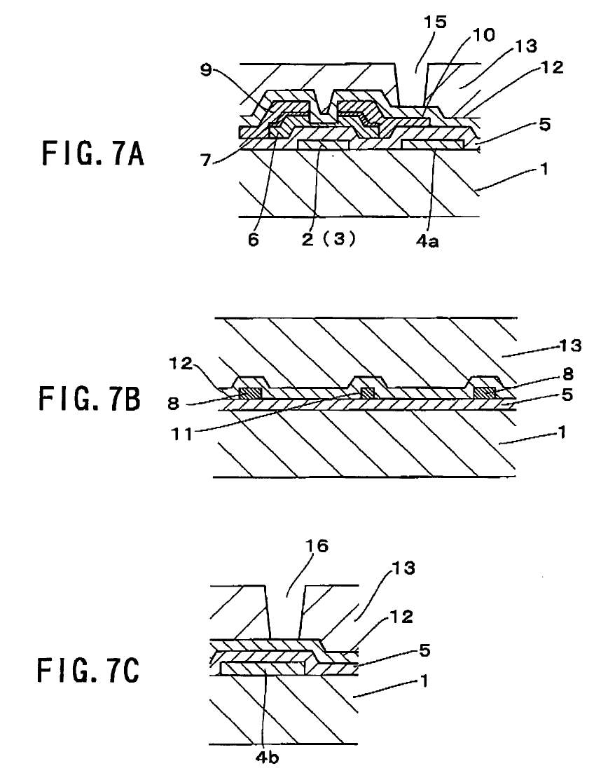

Subsequently, as shown in FIGS. 7A to 7C, the thick organic insulating film 13 is formed on the passivation film 12. For example, a transparent photosensitive acrylic resin may be used for the transparent organic insulating material. A transparent photosensitive acrylic resin is coated on the passivation film 12 by spin coating and then, it is exposed and developed for patterning. In these exposure and development processes, the parts of the acrylic resin corresponding to the contact holes 15 for the pixel electrodes 17 and the contact holes 16 for the common electrode 18, and the unnecessary parts of the said acrylic resin excluding the display region are selectively removed. Thereafter, the said acrylic resin thus patterned is thermally cured by sintering. As a result, the organic insulating film 13 with the structure shown in FIGS. 7A to 7C is formed. A polyimide resin may be used for the transparent organic insulating material.

Next, as shown in FIGS. 5A to 5C, a surface treatment of the organic insulating film 13 is carried out in an atmosphere containing plasma of an inert gas. For example, the plasma treatment is applied to the surface of the organic insulating film 13 using helium (He) gas. As a result, the thin reformed layer 14 is formed in the surface of the organic insulating film 13. At this time, the inner surfaces of the contact holes 15 for the pixel electrodes 17 and the inner surfaces of the contact holes 16 for the common electrode 18 are contacted with the said plasma and therefore, the reformed layer 14 is formed on the inner surfaces of the contact holes 15 and 16 also.

Concretely speaking, for example, the surface treatment of the organic insulating film 13 is carried out for 20 seconds under the condition that the thickness of the organic insulating film 13 is set at a value ranging from 1 μm to 2 μm, the flow rate of He gas is 100 sccm, the pressure of the He gas is 20 Pa, and the output power is 1200 W. In this case, the reformed layer 14 with a thickness of approximately 10 nm to 20 nm is formed. In this surface treatment, any inert gas other than He gas, for example, argon (Ar) gas or Nitrogen (N₂) gas may be used.

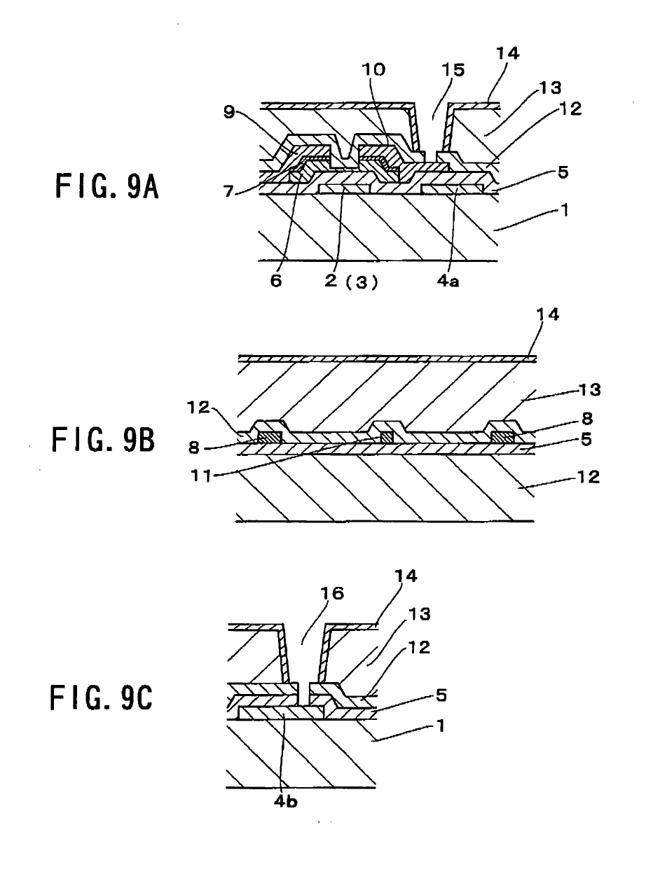

Subsequently, as shown in FIGS. 9A to 9C, the passivation film 12 and the gate insulating film 5 are selectively removed at the positions right below the contact holes 15 and 16 formed to penetrate through the organic insulating film 13 (the reformed layer 14 is formed in the original surface of the said film 13), thereby exposing the drain electrodes 10, the common electrode lines 4b, the gate lines 3, and the data lines 8. In this way, the contact holes 15 for the pixel electrodes 17, the contact holes 16 for the common electrode 18, and the terminal openings (not shown) are completed.

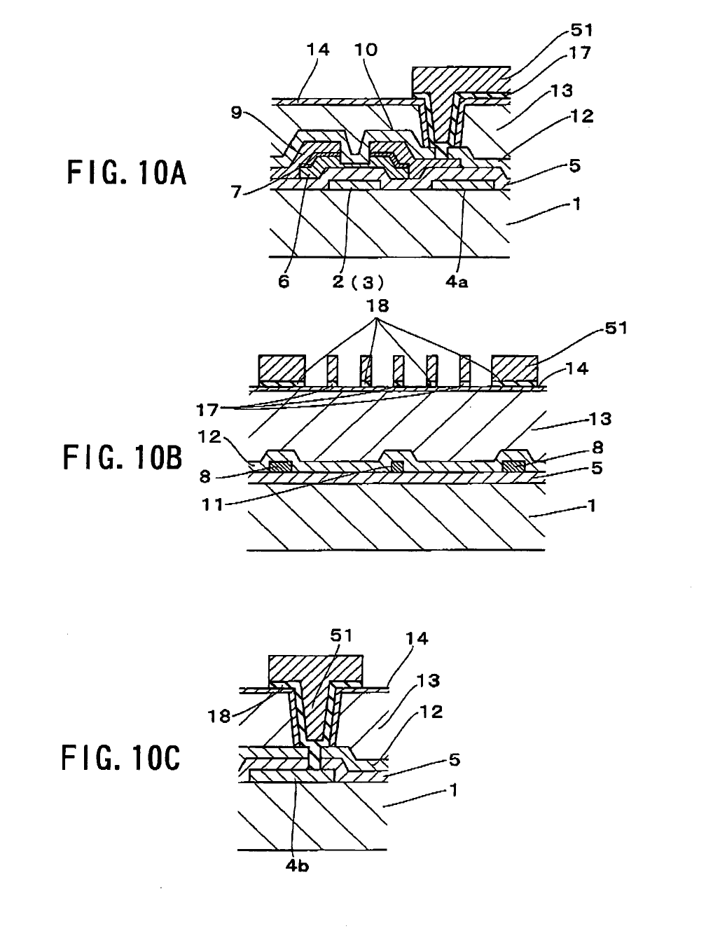

Thereafter, as shown in FIGS. 10A to 10C, as a transparent conductive film, for example, an ITO film is formed on the organic insulating film 13 containing the reformed layer 14 in its original surface. Then, the ITO film thus formed is patterned by photolithography and wet etching, forming the pixel electrodes 17 and the common electrode 18. The pixel electrodes 17 are located on the reformed layer 14 of the organic insulating film 13 (i.e., on the original surface of the organic insulating film 13) in such a way as to cover the corresponding contact holes 15. The pixel electrodes 17 are electrically connected to the corresponding drain electrodes 10 through the corresponding contact holes 15. The common electrode 18 is located on the reformed layer 14 of the organic insulating film 13 (i.e., on the original surface of the organic insulating film 13) in such a way as to cover the contact holes 16. The common electrode 17 is electrically connected to the common electrode lines 4b through the corresponding contact holes 16.

FIGS. 10A to 10C show the state where the photoresist film 51 is left after the patterning of the ITO film by wet etching is completed. The photoresist film 51 is used as the mask in the wet etching process of the ITO film. The reformed layer 14 of the organic insulating film 13 is not yet removed at this stage.

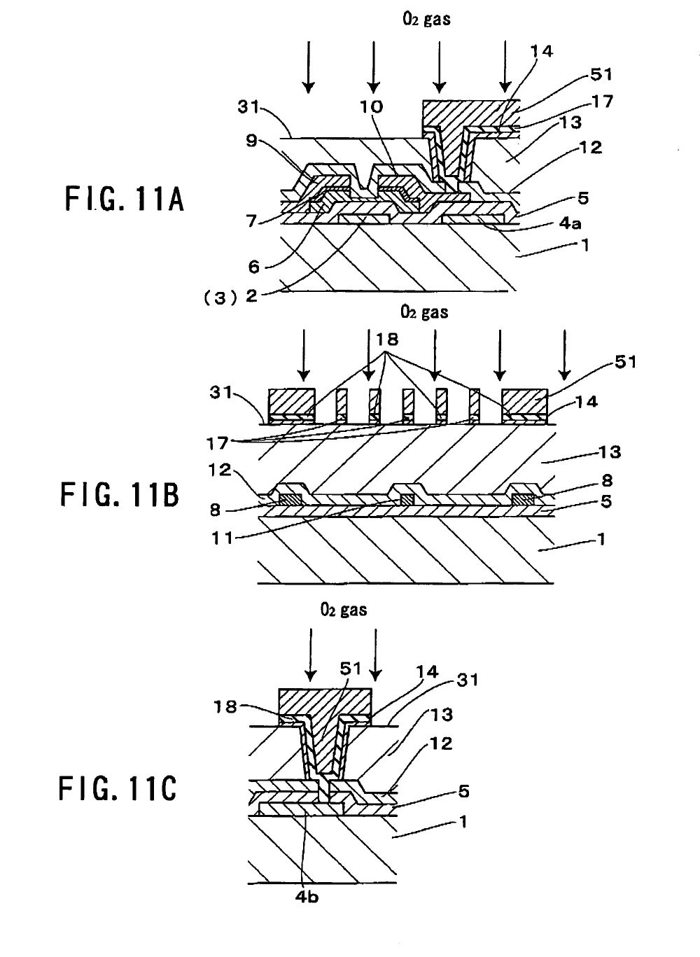

Next, as shown in FIGS. 11A to 11C, using the photoresist film 51 as a mask, the original surface of the organic insulating film 13 (in which the reformed layer 14 is formed) is selectively removed by dry etching using oxygen (O₂) gas. Thus, the reformed layer 14 of the organic insulating film 13 is selectively removed along its thickness direction in the areas where the common and pixel electrodes 16 and 17 do not exist (i.e., in the non-electrode regions). As a result, in the non-electrode regions, the reformed layer 14 is entirely removed and the underlying inner part (i.e., the non-reformed part) of the organic insulating film 13 is exposed. Since the inner part of the organic insulating film 13 has not been reformed (In other words, the transmittance of the said inner part has not been decreased), the transmittance of the organic insulating film 13 in the non-electrode regions is equal to its original transmittance, i.e., the transmittance that the insulating film 13 possesses from the beginning. In this state, the surface 31 of the inner part of the organic insulating film 13 is exposed from the remaining reformed layer 14.

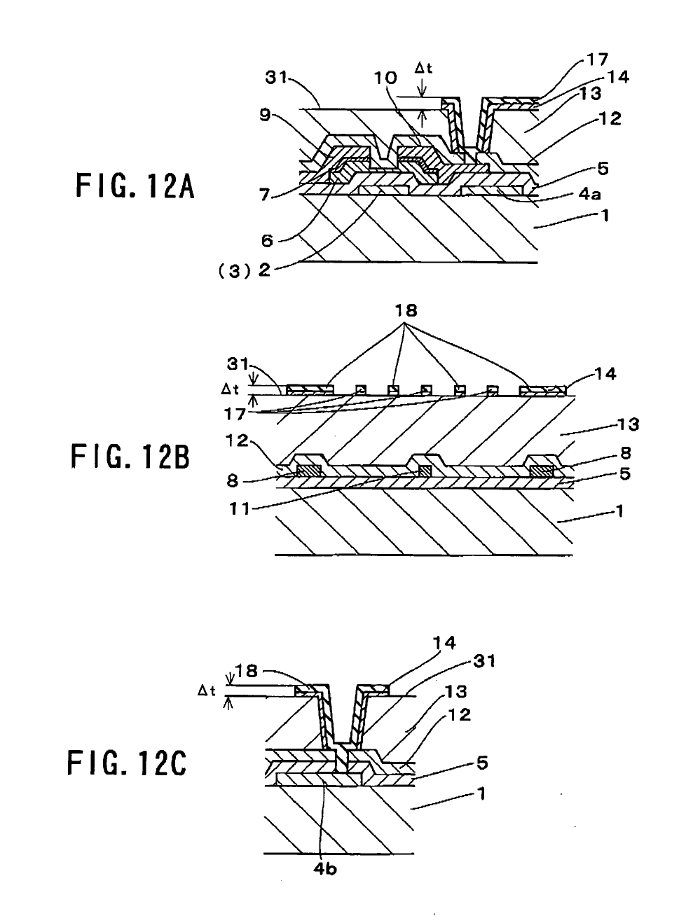

By selectively removing the reformed layer 14 in the non-electrode regions, the level difference Δt is generated between the exposed surface 31 of the inner part of the organic insulating film 13 and the surfaces of the pixel and common electrodes 17 and 18, as shown in FIGS. 12A to 12C. The level difference Δt is equivalent to the sum of the thickness of the pixel and common electrodes 17 and 18 and the removal thickness (i.e., the etching depth) of the original surface of the organic Insulating film 13.

It is preferred that the above-described dry etching process of selectively removing the reformed layer 14 of the organic insulating film 13 in the non-electrode regions is carried out in the state where the photoresist film (mask) 51 is left after the formation of the pixel and common electrodes 17 and 18 by patterning the ITO film is completed. This is because the bad effect of the low transmittance of the pixel and common electrodes 17 and 18, which is caused by the oxidation of the electrodes 17 and 18 by the etching gas (i.e., O₂ gas), is suppressed.

It is needless to say that the above-described dry etching process of selectively removing the reformed layer 14 may be carried out after the photoresist film (mask) 51 is removed. In this case, the pixel and common electrodes 17 and 18 is used as a mask.

In the above-described dry etching process of selectively removing the reformed layer 14, the thicker the inner part of the organic insulating film 13 located below the reformed layer 14 is removed, the higher the transmittance in the non-electrode regions. However, the thicker the inner part of the organic insulating film 13 is removed, the more the level difference Δt between the exposed surface 31 of the organic insulating film 13 and the surfaces of the pixel and common electrodes 17 and 18. As explained above, as the reflection of the level difference Δt, the depressions and projections are generated in the surface of the alignment film 29a that covers the pixel and common electrodes 17 and 18 and the exposed surfaces 31 of the organic insulating film 13 among them, and these depressions and projections will affect the aligning operation of the liquid crystal molecules (see FIG. 5). Accordingly, it is preferred that the removal thickness (i.e. the etching depth) of the organic insulating film 13 is set at as a small value as possible insofar as the advantage of the transmittance improvement by the selective removal of the reformed layer 14 is realized.

According to the inventor's research, it was confirmed that disclination of the liquid crystal molecules did not occur even if the thickness of the pixel and common electrodes 17 and 18 was 40 nm, the removal thickness (the etching depth) of the organic insulating film 13 was 60 nm, and the resultant level difference Δt was 100 nm. Accordingly, it is preferred to adjust the thickness of the pixel and common electrodes 17 and 18 and the removal thickness of the organic insulating film 13 while the level difference Δt is kept at 100 nm or less.

After the above-described dry etching process of selectively removing the reformed layer 14 of the organic insulating film 13 in the non-electrode regions is completed, the remaining photoresist film 51 is peeled off, thereby exposing the pixel and common electrodes 17 and 18. In this way, the TFT array substrate 21 with the structure shown in FIGS. 12A to 12C is produced.

Subsequently, the alignment film 29a is formed on the inner surface of the TFT array substrate 21 and is subjected to a rubbing treatment to a predetermined direction. Then, the polarizer plate 30a is attached to the outer surface of the TFT array substrate 21. Thus, the TFT array substrate 21 has the structure shown in FIG. 5.

Thereafter, the TFT array substrate 21 thus formed is combined with the opposite substrate 22 with the structure of FIG. 5. In this way, the LCD device according to the first embodiment is fabricated.

With the LCD device according to the first embodiment, as explained above, the TFT array substrate 21 comprises the transparent organic insulating film 13 that includes the patterned reformed layer 14 in its surface, and the pixel and common electrodes 17 and 18 formed on the reformed layer 14 by patterning the transparent conductive film such as an ITO film. The reformed layer 14, the transmittance of which is lowered than that of the remaining part (i.e., the inner part) of the transparent organic insulating film 13, has the same pattern as the pixel and common electrodes 17 and 18. The reformed layer 14 is not present in the non-electrode regions where the pixel and common electrodes 17 and 18 do not exist. In the non-electrode regions, the original surface of the transparent organic insulating film 13 is selectively removed in such a way that the removal thickness (i.e. the etching depth) of the said film 13 is greater than the thickness of the reformed layer 14. Thus, the reformed layer 14 does not exist and the inner part of the said film 13 is exposed in the non-electrode regions. The inner part of the transparent organic insulating film 13 is the non-reformed part thereof and is adjacent to the reformed layer 14. Moreover, the level difference Δt is generated between the exposed surface 31 of the inner part (i.e., the non-reformed part) of the transparent organic insulating film 13 and the surfaces of the pixel and common electrodes 17 and 18.

Therefore, in the non-electrode regions where the pixel and common electrodes 17 and 18 do not exist, the reformed layer 14 whose transmittance is relatively lower is not present and thus, the transmittance of the transparent organic insulating film 13 does not deteriorate in the said regions. This means that the transmittance of the transparent organic insulating film 13 in the non-electrode regions is equal to its original transmittance. Accordingly, the display brightness of the said LCD device can be raised.

Moreover, the reformed layer 14 is formed by the surface treatment of the transparent organic insulating film 13 in the atmosphere containing plasma of He gas or the like and is left just below the pixel and common electrodes 17 and 18. In other words, the pixel and common electrodes 17 and 18 are kept in contact with the reformed layer 14 in the electrode regions where the pixel and common electrodes 17 and 18 are overlaid the transparent organic insulating film 13. Therefore, the improved adhesion property between the pixel and common electrodes 17 and 18 and the transparent organic insulating film 13 due to the formation of the reformed layer 14 is kept unchanged. This means that the defective pattering of the pixel and common electrodes 17 and 18 does not occur.

Accordingly, the display brightness can be increased while the defective patterning of the pixel and common electrodes 17 and 18 is prevented.

With the method of fabricating the LCD device according to the first embodiment, as explained above, after the reformed layer 14 is formed in the surface of the transparent organic insulating film 13, the ITO film (i.e., transparent conductive film) for the pixel and common electrodes 17 and 18 (i.e., transparent electrodes) is formed on the reformed layer 14. Thereafter, using the photoresist film 51 as the mask, the ITO film is selectively removed to form the pixel and common electrodes 17 and 18. Subsequently, the parts of the reformed layer 14 that are exposed from the pixel and common electrodes 17 and 18 are selectively removed to reduce the thickness of the transparent organic insulating film 13 (i.e., the reformed layer 14) in the non-electrode regions compared with the thickness of the said film 13 (i.e., the said layer 14) in the electrode regions. For this reason, in the non-electrode regions where the pixel and common electrodes 17 and 18 are not present, the reformed layer 14 with a relatively lower transmittance does not exist and as a result, the transmittance does not decrease in the non-electrode regions. This means that the transmittance of the transparent organic insulating film 13 in the non-electrode regions is equal to the original transmittance thereof and thus, the display brightness can be increased.

Because the reformed layer 14 is formed by the surface treatment of the transparent organic insulating film 13 in the atmosphere containing plasma of He gas or the like and is left just below the pixel and common electrodes 17 and 18, the improved adhesion property between the pixel and common electrodes 17 and 18 and the transparent organic insulating film 13 due to the formation of the reformed layer 14 is kept unchanged. This means that the defective pattering of the pixel and common electrodes 17 and 18 does not occur.

Accordingly, with the fabrication method according to the first embodiment also, the display brightness can be increased while the defective patterning of the pixel and common electrodes 17 and 18 is prevented.

### Second Embodiment

Subsequently, a LCD device operating in the IPS mode according to a second embodiment and a method of fabricating the device will be explained below.

The LCD device according to the second embodiment has the same structure as the LCD device according to the first embodiment except that the reformed layer 14 is partially left in the non-electrode regions where the pixel and common electrodes 17 and 18 are not present.

In the above-described first embodiment, the reformed layer 14 is entirely removed in the non-electrode regions. However, in the case where the level difference generated between the exposed surface 31 and the surfaces of the pixel and common electrodes 17 and 18 by removing the whole thickness of the reformed layer 14 is excessively large in the non-electrode regions, and some problem (e.g., disclination) will occur, the thickness of the reformed layer 14 may be partially removed. The LCD device of the second embodiment is suitable for such the case.

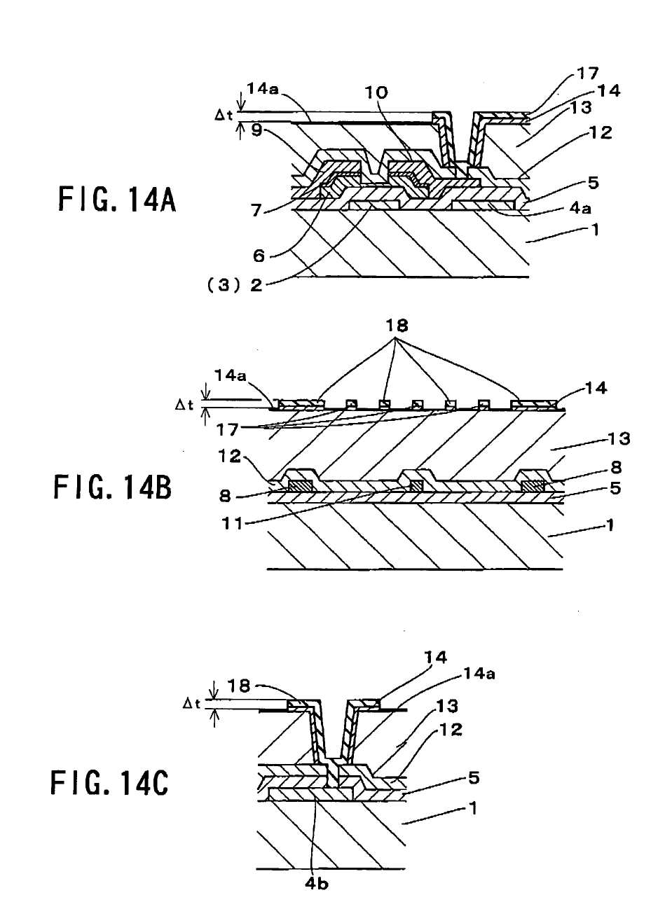

With the LCD device according to the second embodiment, as shown in FIGS. 14A to 14C, the surface of the inner part (i.e., the non-reformed part) of the transparent organic insulating film 13 is covered with the remainder 14a of the reformed layer 14 in the non-electrode regions where the pixel and common electrodes 17 and 18 are not present. In other words, the remainder 14a of the reformed layer 14 is left in the surface of the transparent organic insulating film 13 in the non-electrode regions. The inner part of the transparent organic insulating film 13 is not exposed not only in the electrode regions but also in the non-electrode regions. The other structure is the same as that of the LCD device according to the above-described first embodiment.

Because the remainder 14a of the reformed layer 14 is left in the surface of the transparent organic insulating film 13 in the non-electrode regions in the LCD device according to the second embodiment, the obtainable transmittance improvement is less than that of the first embodiment. However, taking the fact the reformed layer 14 is formed by surface treatment of the transparent organic insulating film 13 into consideration, it may be thought that the transmittance of the reformed layer 14 is the lowest on its surface and it increases gradually with the increasing distance or depth from the said surface. Therefore, when at least the outermost part of the reformed layer 14 is removed, the obtainable transmittance improvement can be suppressed to a level slightly lower than that of the first embodiment, even if the remainder 14a is left thereon.

Accordingly, the LCD device according to the second embodiment is suitable for the case where the level difference generated between the exposed surface 31 and the surfaces of the pixel and common electrodes 17 and 18 by removing the whole thickness of the reformed layer 14 is excessively large in the non-electrode regions, and some problem (e.g., disclination) will occur. Moreover, even in such the case, the advantage of the transmittance improvement can be realized while the above-identified problem is prevented.

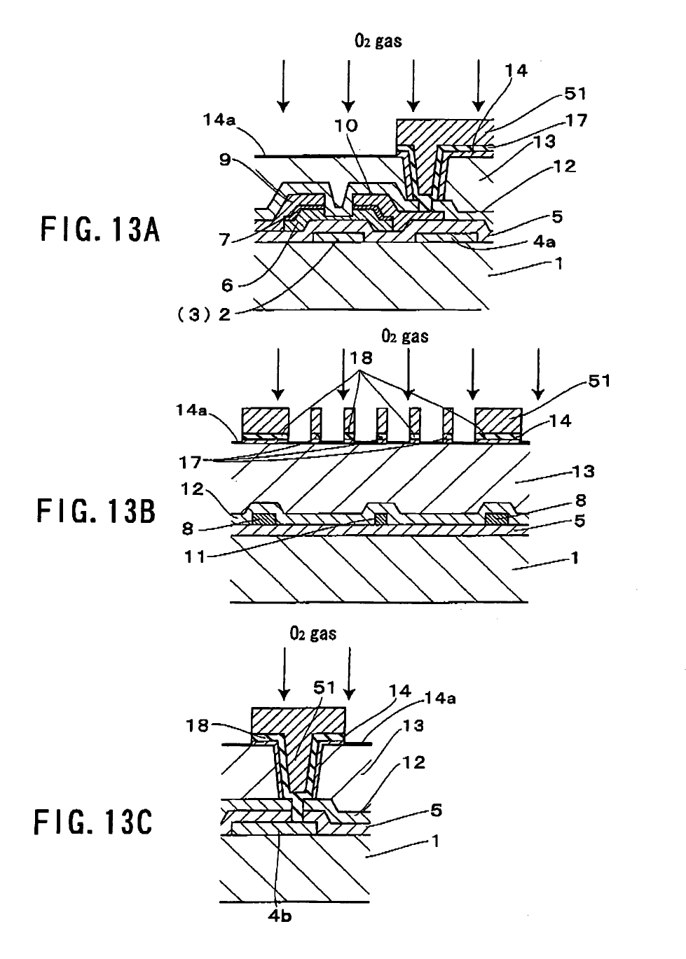

Next, a method of fabricating the LCD device according to the second embodiment will be explained below with reference to FIGS. 13A to 13C to FIGS. 14A to 14C. FIGS. 13A to 13C correspond to FIGS. 11A to 11C in the first embodiment. Similarly, FIGS. 14A to 14C correspond to FIGS. 12A to 12C in the first embodiment.

In the fabrication method of the second embodiment also, the same process steps as those of the fabrication method of the first embodiment are carried out until the step of forming the photoresist film 51 as the mask on the reformed layer 14 of the transparent organic insulating film 13 (see FIGS. 11A to 11C).

Next, as shown in FIGS. 13A to 13C, using the photoresist film 51 as a mask, the original surface of the organic insulating film 13 (in which the reformed layer 14 is formed) is selectively removed by dry etching using, for example, oxygen (O₂) gas. Due to this etching, the reformed layer 14 of the organic insulating film 13 is selectively removed along its thickness direction in the non-electrode regions. This point is the same as the first embodiment. However, this dry etching is stopped before the whole thickness of the reformed layer 14 is removed, thereby leaving the remainder 14a of the reformed layer 14 in the surface of the organic insulating film 13 in the non-electrode regions. This point is unlike the first embodiment.

Thereafter, the photoresist film 51 is detached to expose the pixel and common electrodes 17 and 18, resulting in the state shown in FIGS. 14A to 14C. In this state, a level difference Δt is generated between the surface of the remainder 14a of the reformed layer 14 and the surfaces of the pixel and common electrodes 17 and 18. In this way, the TFT array substrate 21 is produced.

Following this, the alignment film 29a is formed on the inner surface of the TFT array substrate 21 thus produced, and is subjected to a rubbing treatment to a predetermined direction. Then, the polarizer plate 30a is attached to the outer surface of the TFT array substrate 21. Thus, the TFT array substrate 21 with a similar structure to that of FIG. 5 is formed.

Thereafter, the TFT array substrate 21 thus formed is combined with the opposite substrate 22 with the structure of FIG. 5. In this way, the LCD device according to the second embodiment is fabricated.

### Third Embodiment

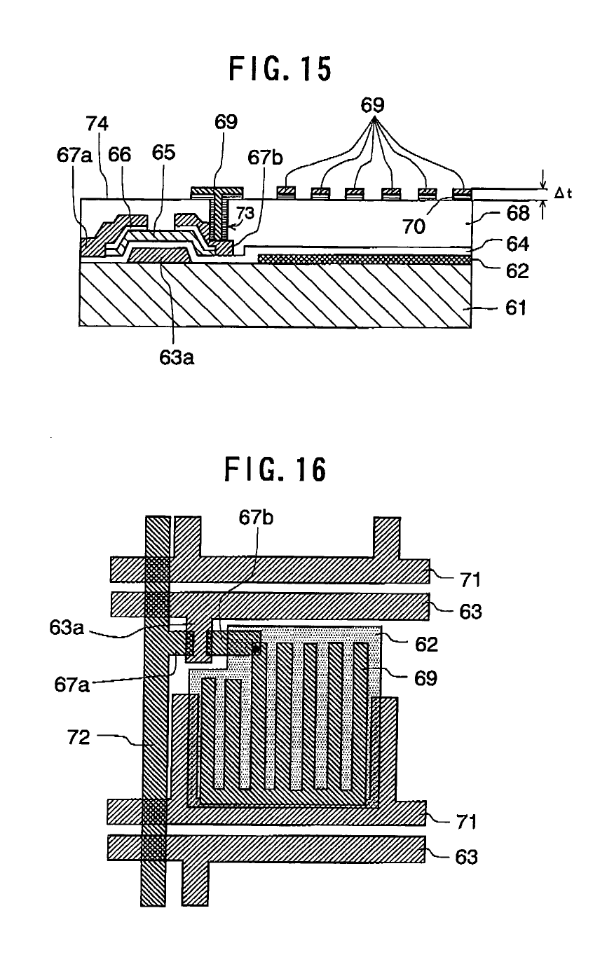

FIGS. 15 and 16 show the structure of a TFT array substrate used in a LCD device operating in the FFS mode according to a third embodiment of the present invention. These figures show the structure of one of the pixel regions arranged in a matrix array.

This LCD device is fabricated in the following way.

First, an ITO film is deposited on a transparent plate 61 and patterned, thereby forming counter electrodes 62 on the plate 61. Then, a metal film is deposited on the plate 61 and patterned, thereby forming gate lines 63, gate electrodes 63a, and common electrode lines 71 on the plate 61. The gate electrodes 63a are united with the corresponding gate lines 63. At this time, the common electrode lines 71 are in contact with the counter electrode 62. The gate lines 63 are extended laterally (i.e., from side to side). The common electrode lines 71 are extended parallel to the gate lines 63.

Subsequently, a gate insulating film 64 is formed on the plate 61 to cover the counter electrodes 62, the gate lines 63, the gate electrodes 63a, and the common electrode lines 71. Each of the counter electrodes 62 comprises an approximately square plan shape.

Next, on the gate insulating film 64, an a-Si or p-Si film is formed on the gate insulating film 64 and then, a heavily doped a-Si or p-Si film is formed on the a-Si or p-Si film thus formed. Thereafter, these two semiconductor films are patterned to be islands, thereby forming semiconductor islands 65 and heavily doped semiconductor islands 66 located thereon.

Next, a metal film is formed on the gate insulating film 64 to cover the semiconductor islands 65 and 66. Then, the metal film is patterned in such a way as to overlap with the both sides of the semiconductor islands 66 and the predetermined parts of the gate lines 63, thereby forming source electrodes 67a, drain electrodes 67b, and data lines 72 on the gate insulating film 64.

Subsequently, a thick transparent organic insulating film 68 is formed on the gate insulating film 64 to cover the source electrodes 67a, the drain electrodes 67b, and the data lines 72. The transparent organic insulating film 68 thus formed is selectively etched to form contact holes 73 at predetermined positions that overlie the drain electrode 67b. The drain electrode 67b are exposed from the said film 68 by way of the corresponding contact holes 73, as shown in FIG. 15.

Following this, a surface treatment of the organic insulating film 68 is carried out in the same way as the first embodiment. Thus, a thin reformed layer 70 is formed in the surface of the organic insulating film 68. At this time, the reformed layer 70 is formed on the inner surfaces of the contact holes 73 also.

Further, an ITO film is formed on the reformed layer 70 of the organic insulating film 68 and then, is patterned by photolithography and wet etching, forming pixel electrodes 69. The pixel electrodes 69 are in contact with the reformed layer 70 (i.e., the original surface of the organic insulating film 68). The pixel electrodes 69 are electrically connected to the corresponding drain electrodes 67b through the corresponding contact holes 73. Each of the pixel electrodes 69 comprises comb-tooth shaped parts, as shown in FIG. 16.

Next, using the same mask as used for the formation of the pixel electrodes 69, the original surface of the reformed layer 70 of the organic insulating film 68 is selectively removed along its thickness direction in the non-electrode regions where the pixel electrodes 69 do not exist. As a result, in the non-electrode regions, the reformed layer 70 is entirely removed and the underlying inner part (i.e., the non-reformed part) of the organic insulating film 68 is exposed. In this state, the surface 74 of the inner part of the said film 68 is exposed from the remaining reformed layer 70.

By selectively removing the reformed layer 70 in the non-electrode regions, a level difference Δt is generated between the exposed surface 74 of the inner part of the organic insulating film 68 and the surfaces of the pixel electrodes 69, as shown in FIG. 15. The level difference Δt is equivalent to the sum of the thickness of the pixel electrodes 69 and the removal thickness (i.e., the etching depth) of the original surface of the organic insulating film 68.

After the above-described dry etching process of selectively removing the reformed layer 70 of the organic insulating film 68 in the non-electrode regions is completed, the remaining photoresist film is peeled off, thereby exposing the pixel electrodes 69. In this way, the TFT array substrate with the structure shown in FIGS. 15 and 16 is produced.

Subsequently, an alignment film 29a is formed on the inner surface of the TFT array substrate and is subjected to a rubbing treatment to a predetermined direction. Then, a polarizer plate 30a is attached to the outer surface of the TFT array substrate.

Thereafter, the TFT array substrate thus formed is combined with the opposite substrate with the structure of FIG. 5. In this way, the LCD device according to the third embodiment is fabricated.

With the TFT array substrate of the LCD device according to the third embodiment, as explained above, the TFT array substrate comprises the transparent organic insulating film 68 that includes the patterned reformed layer 70 in its surface, and the pixel electrodes 69 formed on the reformed layer 70. The reformed layer 70, the transmittance of which is lowered than that of the remaining part (i.e., the inner part) of the transparent organic insulating film 68, has the same pattern as the pixel electrodes 69. The reformed layer 70 is not present in the non-electrode regions where the pixel electrodes 69 do not exist. The level difference Δt is generated between the exposed surface 74 of the inner part (i.e., the non-reformed part) of the transparent organic insulating film 68 and the surfaces of the pixel electrodes 69.

Therefore, the transmittance of the transparent organic insulating film 68 in the non-electrode regions is equal to its original transmittance. Accordingly, the display brightness of the said LCD device can be raised.

Moreover, since the reformed layer 70 is formed by the surface treatment of the transparent organic insulating film 68 in the atmosphere containing plasma of He gas or the like and is left just below the pixel electrodes 69, the pixel electrodes 69 are kept in contact with the reformed layer 70 in the electrode regions where the pixel electrodes 69 are overlaid the transparent organic insulating film 68. Therefore, the improved adhesion property between the pixel electrodes 69 and the transparent organic insulating film 68 due to the formation of the reformed layer 70 is kept unchanged. This means that the defective pattering of the pixel electrodes 69 does not occur.

Accordingly, similar to the above-described first and second embodiments, the display brightness can be increased while the defective patterning of the pixel electrodes 69 is prevented in the LCD device according to the third embodiment also.

### Other Embodiments

The above-described first to third embodiments are preferred examples of the present invention. Therefore, needless to say, the present invention is not limited to these embodiments and any modification is applicable to them.

For example, although oxygen gas is used in the dry etching process for removing the reformed layer in the above-described first to third embodiments, any other etching gas may be used for this purpose if the reformed layer can be removed by it. For example, a gaseous mixture of sulfur hexafluoride (SP₆) and helium (He), a gaseous mixture of carbon tetrafluoride (CF₄) and oxygen (O₂), a gaseous mixture of trifluoromethane (CHF₃) and oxygen (O₂), or a gaseous mixture of carbon tetrafluoride (CF₄), trifluoromethane (CHF₃), and oxygen (O₂) may be used for this purpose.

Moreover, the pixel electrodes and the common electrodes are formed by patterning the ITO film (i.e., the transparent conductive film) located on the organic insulating film in the first and second embodiments. However, as shown in the third embodiment, either the pixel electrodes or the common electrodes may not be located on the organic insulating film. The electrodes that are not located on the organic insulating film may be made of an opaque material (e.g., a metal).

The data lines, the pixel electrodes, and the common electrodes are extended linearly in the first and second embodiments, and the data lines and the pixel electrodes are extended linearly in the third embodiment. However, they may not be extended linearly if they are parallel. For example, they may be bent at fixed angles with respect to the extending direction of the data lines to form a zigzag pattern.

The LCD device is operated in the IPS mode in the first and second embodiments, and is operated in the FFS mode in the third embodiment. However, the invention is not limited to these two modes. The present invention may be applied to any lateral electric-field type LCD device that is operated in any other mode than the IPS and FFS modes if it comprises the structure that transparent electrodes are formed on an organic transparent insulating film, and the areas where the transparent electrodes do not exist are utilized as the optical transmission regions.

Although the reformed layer is formed by a surface treatment of the organic insulating film in an atmosphere containing plasma of an inert gas (e.g. He gas) in the first to third embodiments, the reformed layer may be formed by any other method if the adhesion property between the organic insulating film and the transparent electrodes (e.g., pixel electrodes and/or common electrodes) formed thereon may be improved. For example, the reformed layer may be formed by irradiating ultraviolet (UV) rays to the surface of the organic insulating film.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A liquid crystal display device comprising:
a transparent substrate;
an organic transparent insulating film formed on or over the substrate, the organic transparent insulating film including a reformed layer in its surface; and
transparent electrodes formed on the organic transparent insulating film to be in contact with the reformed layer;
wherein in electrode regions where the transparent electrodes are present, the reformed layer has a first thickness; and
in non-electrode regions where the transparent electrodes are not present, the reformed layer is not present, or a remainder of the reformed layer is present in such a way as to have a thickness less than the first thickness.

2. The device according to claim 1, wherein in the non-electrode regions, a predetermined level difference is generated between a surface of an inner part of the organic transparent insulating film or the remainder of the reformed layer, and surfaces of the transparent electrodes; and
the level difference is set at a value in a range where a disclination of liquid crystal molecules does not occur.

3. The device according to claim 2, wherein the level difference is set at a value in a range from 100 nm to 20 nm.

4. The device according to claim 1, wherein the reformed layer is not present such that an inner part of the organic transparent insulating film is exposed in the non-electrode regions.

5. The device according to claim 1, wherein the remainder of the reformed layer whose thickness is less than the first thickness is present, and an inner part of the organic transparent insulating film is not exposed from the remainder in the non-electrode regions.

6. The device according to claim 1, wherein the transparent electrodes are pixel electrodes and/or common electrodes.

7. A method of fabricating a liquid crystal display device, comprising the steps of:
forming an organic transparent insulating film on or over a transparent substrate;
reforming a surface of the organic transparent insulating film, thereby forming a reformed layer in the surface of the organic transparent insulating film, wherein the reformed layer has a first thickness;
forming a transparent conductive film on the reformed layer;
selectively removing the transparent conductive film, thereby forming transparent electrodes, wherein the transparent electrodes are in contact with the reformed layer, and the reformed layer is exposed in non-electrode regions where the transparent electrodes are not present; and
selectively removing the exposed reformed layer in the non-electrode regions along a thickness direction of the organic transparent insulating film, thereby removing the reformed layer or reducing a thickness of the reformed layer;
wherein in the non-electrode regions, the reformed layer is not present, or a remainder of the reformed layer is present in such a way as to have a thickness less than the first thickness.

8. The method according to claim 7, wherein in the step of selectively removing the exposed reformed layer to reduce the thickness thereof, a predetermined level difference is generated between a surface of the inner part of the organic transparent insulating film or the remainder of the reformed layer, and surfaces of the transparent electrodes in the non-electrode regions; and
the level difference is set at a value in a range where disclination of liquid crystal molecules does not occur.

9. The method according to claim 8, wherein the level difference is set at a value in a range from 100 nm to 20 nm.

10. The method according to claim 7, wherein in the step of selectively removing the exposed reformed layer to reduce the thickness thereof, a removal thickness or depth of the reformed layer is greater than the first thickness; and
the reformed layer is not present such that an inner part of the organic transparent insulating film is exposed in the non-electrode regions.

11. The method according to claim 7, wherein in the step of selectively removing the exposed reformed layer to reduce the thickness thereof, a removal thickness or depth of the reformed layer is less than the first thickness; and
the remainder of the reformed layer whose thickness is less than the first thickness is present, and an inner part of the organic transparent insulating film is not exposed from the remainder in the non-electrode regions.

12. The method according to claim 7, wherein in the step of selectively removing the exposed reformed layer to reduce the thickness thereof, the transparent electrodes are used as a mask.

13. The method according to claim 7, wherein in the step of selectively removing the exposed reformed layer to reduce the thickness thereof, a same mask as that used in the step of selectively removing the transparent conductive film to form transparent electrodes is used.

14. The method according to claim 7, wherein in the step of reforming the surface of the organic transparent insulating film, the reformed layer is formed by surface treatment of the organic transparent insulating film in an atmosphere containing plasma of an inert gas.
